(19) United States
(12) Patent Application Publication
(10) Pub. No.: US 2014/0342890 A1
(43) Pub. Date: Nov. 20, 2014

(54) Crimper System

(71) Applicant: THE GATES CORPORATION, DENVER, CO (US)

(72) Inventor: Donald R. Gilbreath, Castle Rock, CO (US)

(21) Appl. No.: 14/369,380

(22) PCT Filed: Dec. 21, 2012
(86) PCT No.: PCT/US2012/071149

§ 371 Date: Jun. 27, 2014

Related U.S. Application Data
(60) Provisional application No. 61/582,312, filed on Dec. 31, 2011.
(60) Provisional application No. 61/582,317, filed on Dec. 31, 2011.
(60) Provisional application No. 61/582,315, filed on Dec. 31, 2011.

(51) Int. Cl. B21D 39/04; B25B 27/14

(52) U.S. Cl. CPC B21D 39/048; B25B 27/14
USPC 483/1; 29/237

(57) ABSTRACT

A crimper system (300) having a slide frame with a base (310) and a movable head (320) slidably mounted on the slide frame, with a crimp zone (126) opening defined between the base and head includes a dual compound leverage mechanism having two tension arms (332, 330) with lower ends pivotably attached to the base; two compression arms with lower ends pivotably attached to the movable head; and the upper end of each tension arm pivotably attached to the upper end of a corresponding one of the compression arms (334,336) forming two elbow joints defining acute angles between each tension arm and its corresponding compression arm; a screw drive mechanism (350); and a stepped crimp-setting mechanism. Also provided is a tool, system and method for quick, easy removal, installation and storage of multiple-die, crimper die sets. The system includes a set of interconnected dies. The tool engages the connectors for pulling the die set out of a crimper.

### BACKGROUND OF THE INVENTION

1. Field of the Invention

This invention relates generally to a crimper for cylindrical couplings, more particularly to a compact, mechanically activated crimper system, and specifically to a screw-operated, dual arm crimping system with a die carrier system of intermeshing, overlapping portions of die carriers, a die system of interconnected dies, a hand tool for changing crimper die sets, and a stop mechanism.

2. Description of the Prior Art

There are many types of crimping machines, i.e., crimpers, for crimping an outer work piece onto an inner work piece. Virtually all devices currently used to crimp hydraulic hose assemblies, i.e., to crimp hydraulic hose end fittings including ferrules, require hydraulic pumps and cylinders. One type of crimper available in the market today utilizes a hydraulic cylinder to ram a set of die segments axially through a generally cone-shaped head as exemplified by U.S. Pat. No. 6,178,802 to Reynolds. A variation on this theme utilizes an annular hydraulic cylinder to achieve the same ends, which is much more expensive, but provides better clearance for installation, crimping, and removal of various configurations of hose and fittings.

Radial crimpers are also available which use a hydraulic cylinder oriented normal to the crimp axis to force a set of die fingers radially together as exemplified by U.S. Pat. No. 6,257,042, which has an open throat press, and U.S. Pat. No. 4,854,031, which has a closed frame.

U.S. Pat. No. 5,257,525 to Clarke discloses a portable, screw-operated crimper which is used for so-called bubble crimps on air-conditioning hoses. The screw applies force perpendicular to and directly toward the central axis of the crimper zone.

U.S. Pat. No. 4,561,282 discloses a pliers-type, hand-held crimper utilizing a diminishing-arm, toggle linkage to enhance the crimp force.

U.S. Pat. Appl. Pub. No. 2011/0023573 A1 discloses a die carrier assembly for use in a crimping machine. The die carriers define interdigitated fingers that support a die shoe when the die carrier assembly is at its maximum opening position. Various types of dies can be assembled to the die carrier assembly, i.e., mounted to the radial inner extents of the shoes, so that the crimping diameter of the die carrier assembly is less than the minimum shoe opening.

There are also various tools to handle the installation, removal, storage or changing of various styles of die sets have been developed.

U.S. Pat. No. 7,497,106 to Beining and U.S. Pat. No. 6,257,042 to Valimaki et al. disclose a quick change tool for a crimper die set. The die set comprises a number, typically eight, of die segments which are removably mounted onto a corresponding set of master dies which retain the die segments in the tool. The quick change tool comprises a plate coupled to a handle. The plate has a number of fingers adapted to mate with corresponding apertures in each die segment. The installation and removal of die segments from the master dies requires operating the crimper while the fingers are inserted in the apertures.

U.S. Pat. No. 5,243,846 discloses an apparatus for loading and unloading die sets in which each individual die segment is slidably mounted on its corresponding die shoe, e.g., with an axially oriented dovetail projection on each die segment which mates with a groove on each shoe. The loading device includes a container to house the die segments and a plunger sized to pass through the container and through the die set when the dies are in the open position only. After inserting the plunger through the die set, the crimper is actuated to move the dies into the closed position, where pulling on the plunger pulls the die segments into the container. For installation, the plunger is used to push the die segments onto the shoes. Loading and/or unloading the dies requires careful alignment of the several dovetail joints by operation of the crimper.

U.S. Pat. No. 7,526,940 discloses a die element change tool with a handle, a movable part with a number of arms and a fixed part with a number of retaining features on each arm and each fixed part. With the dies in the open position, the arms can be inserted between the dies and rotated so that the retaining features on the arms engage the back side of the dies and the retaining features on the fixed part engage the front side of the die elements. The dies are thus held between the arms and fixed part for simultaneously unloading or loading, with a similar axial dovetail sliding movement as the '846 patent. A spring in the handle biases the movable part towards the fixed part to facilitate retention of the die elements. The tool does not require operation of the crimper, only that the dies be in the open position. However, removal of the dies from the tool for storage does not appear to be easy. Multiple tools may be needed to handle multiple die sets.

Various methods to set a stop position for a crimper have been tried. Some are relatively inexpensive but can be cumbersome and time consuming for the user. Faster methods can be expensive. Some methods will not have adequate strength to withstand the possible over-torque of the drive screw. What is needed is a screw stop for a crimper that avoids these problems.

### SUMMARY

The present invention is directed to crimper systems and methods which provide compact or portable crimping with mechanical force enhancement. The invention also provides excellent clearance for installation, crimping, and removal of various configurations of hose and fittings. The invention also provides for easy calibration and adjustment of the crimp. The invention also provides a die cage and crimper die set which provide easy installation and removal of the crimper die set.

The invention is directed to a crimper system having a slide frame with a base and a movable head slidably mounted on the slide frame, with a crimp zone opening defined between the base and head. There is a dual compound leverage mechanism having two tension arms with lower ends pivotably attached to the base; two compression arms with lower ends pivotably attached to the movable head; and the upper end of each tension arm pivotably attached to the upper end of a corresponding one of the compression arms forming two elbow joints defining acute angles between each tension arm and its corresponding compression arm. There is a drive mechanism adapted to pull the two elbows toward each other, thereby driving the head toward the base to perform a crimp. The tension arms are longer than the compression arms and sized to provide a large increase in force as the arms approach a vertical aligned position.

According to an embodiment of the invention, the drive mechanism comprises a screw connecting the two elbows and increasing the mechanical advantage further. The screw may be drivable by an electric or pneumatic drill. In other embodiments the drive mechanism may be a hydraulic or pneumatic cylinder, or two lever arms extending from the two tension arms.

According to an embodiment of the invention, the crimping zone may be of generally octagonal shape defined between the head and base. In the crimp zone may be mounted a polygonal die cage having an polygonal outer perimeter which fits within the crimp zone, and an polygonal inner perimeter which is oriented concentric with the outer perimeter and rotated about half the included angle of a polygonal side relative to the outer perimeter. The polygon may be an octagon, and the die cage may consist of four intermeshing sliders. The sliders may be biased outward by a generally circular spring housed within a groove extending around the inner periphery of the die cage.

According to an embodiment of the invention, the systems and methods work with crimpers which utilize a set of sliders which define a polygonal opening and with die sets in which a die normally sits in each vertex of the polygonal opening. The dies are preferably interconnected as a set by means of die connectors. The dies may also include means to engage with the sliders, such as protrusions on their outer surfaces that engage in recesses on the sliders whereby in the normal crimping position the dies are restrained from axial movement, but when rotated, for example by an amount equal to half the included angle of a side of the polygon, the dies disengage from the sliders and can then be removed axially without interference.

According to an embodiment of the invention, hydraulic actuation is not required to crimp hydraulic hose fittings. The crimper may be powered with a handheld electric or pneumatic drill or even manually.

The present invention is also directed to systems and methods which provide for quick, easy removal, installation and storage of multiple-die, crimper die sets. The systems and methods work with the crimper in the open position, and no operation of the crimper is required during removal or installation. The systems and methods work with crimpers which utilize a set of sliders which define a polygonal opening and with die sets in which a die normally sits in each vertex of the polygonal opening. The dies must be interconnected as a set by means of die connectors. The dies also include means to engage with sliders, such as protrusions on their outer surfaces that engage in recesses on the sliders whereby in the normal crimping position the dies are restrained from axial movement, but when rotated, for example by an amount equal to half the included angle of a side of the polygon, the dies disengage from the sliders and can then be removed axially without interference.

According to the present invention, the die change tool includes a can, a handle and a rotator. The handle and rotator are connected and move as a unitary die rotator assembly. The can is slidably mounted on the die rotator assembly so the die rotator can be pulled into the can or pushed out. The die rotator has legs which may correspond in number and spacing to the spaces between dies when the crimper is in the open position. Inserting the rotator between the dies and turning the handle causes the rotator legs to push against the sides of the dies, thus rotating the die set within the slider opening and disengaging the dies from the sliders. At the same time, due to the rotation of a polygonal die set within a polygonal opening, the dies move radially inward, causing the die connectors to engage with a step or detent on each leg. Then pulling on the handle causes the rotator legs to pull the die set out of the slider opening and into the can.

The die connectors may include springs which bias the dies away from each other and thus radially outward. The can may have alignment guides to align it with the polygonal opening and to prevent the can from rotating with respect to the slider opening. The can opening may correspond in size and shape with the slider opening.

The rotator assembly may have a guide track which interacts with a guide protrusion on the can, thus limiting relative motion between the rotator assembly and the can. The relative motion between the rotator assembly and the can may thus be limited in the axial direction to approximately the length of a die and/or the rotational motion may be limited to the angular rotation needed to engage and disengage the die set from the sliders, i.e. about half the included angle of a polygon side.

There may be a spring biasing the handle away from the can, thus tending to pull the rotator into the can. With such a spring and with alignment guides, the die removal tool can be easily operated with one hand on the handle.

The invention is also directed to a die change system which includes an embodiment of the die change tool and a die set having a plurality of dies connected together. The sliders define a polygonal opening. Each die of the die set has two outer surfaces defining an angle equal to the interior angle of a vertex of the polygonal opening so that the die can sit in a vertex of the polygonal opening. The dies are interconnected as a set by means of die connectors. The dies also may include protrusions on their outer surfaces that engage in recesses on the sliders whereby in the normal crimping position the dies are restrained from axial movement, but when rotated, for example by an amount equal to half the included angle of a side of the polygon, the dies disengage from the sliders and can then be removed axially without interference.

The invention is also directed to methods that include the steps of inserting a die rotator into the spaces of a die set, rotating the die set by turning the handle attached to the die rotator, engaging a detent on the die rotator with a die connector, and pulling the die set out of a crimper and into a can.

The invention is also directed to methods that include the steps of aligning a die change tool with a crimper, pushing a die set housed in a can on the tool out of the can and into a crimper by means of a handle on the tool, rotating the die set by turning the handle during which the dies engage with sliders on the crimper, and removing the tool from the spaces of the die set.

The invention is also directed to a stair-step crimp stop which is easily adjusted through a large range of stop lengths. Steps may be straight or may include a back angle to urge a tighter lock under load. The stepped stop may be held in place with a thumbscrew, wing nut, or the like, or be spring-loaded for even quicker adjustment. The stop arrangement is such that it behaves much like solid material and can withstand the full force of the lead screw in a screw-operated crimper. The stop thus provides a positive stop for a lead screw that drives a crimper.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is a front elevation of a portion of a crimper in the open position with sliders and a die set which is removable according to an embodiment of the invention;

FIG. 2 is a front elevation of a portion of the crimper of FIG. 1 in the closed position;

FIG. 3 is a front elevation of a part of the crimper of FIG. 1 in the open position with a die set which has been rotated for removal according to an embodiment of the invention;

FIG. 4 is a perspective view of an individual die useful with an embodiment of the invention;

FIG. 5 is a perspective view of an individual slider useful with an embodiment of the invention;

FIG. 6 is a front elevation of a crimper apparatus in the open position according to a first embodiment of the invention;

FIG. 7 is a front elevation of the crimper apparatus of FIG. 6 in the closed position;

FIG. 8 is an exploded perspective view of a crimper apparatus according to a second embodiment of the invention;

FIG. 9 is a perspective view of the crimper apparatus of FIG. 8 assembled;

FIG. 10 is a perspective view of the calibration mechanism of the embodiment of FIG. 8;

FIG. 11 is a perspective view of an alternative calibration and stop mechanism;

FIG. 12 is a perspective view of an alternative calibration mechanism;

FIG. 13 is a perspective view of a circular spring useful in embodiments of the invention;

FIG. 14 is a perspective view of a crimper apparatus according to a third embodiment of the invention;

FIG. 15 is a perspective view of a portion of another circular spring useful in embodiments of the invention; and

FIG. 16 is a perspective view of yet another circular spring useful in embodiments of the invention.

FIG. 17 is an exploded perspective view of a die removal tool according to an embodiment of the invention;

FIG. 18 is an exploded perspective view of a die removal tool according to another embodiment of the invention; and

FIG. 19 is a perspective view from a different angle of the handle of the embodiment of FIG. 18.

FIG. 20 is a perspective view of a first bushing according to an embodiment of the stop mechanism invention;

FIG. 21 is a perspective view of a stop member according to an embodiment of the invention;

FIG. 22 is a perspective view of a second bushing according to an embodiment of the stop mechanism invention;

FIG. 23 is a perspective view of a stop assembly according to an embodiment of the stop mechanism invention;

FIG. 24 is a perspective view of a crimper system according to an embodiment of the stop mechanism invention; and

### DETAILED DESCRIPTION

This invention relates to a crimper apparatus and system that can be made relatively inexpensively, and which has advantages over conventional crimper designs. The crimper apparatus is relatively light weight and can be made highly portable. Relatively light weight, portable, electric or pneumatic drives may be used, such as a simple drill, air wrench, or cylinder. The crimper may be screw-driven. Crimper dies can be flush with the face of the crimper providing exceptional crimp clearance. Crimper dies may have a large closure or crimping range relative to the size of the crimping head. Die movement (from open to closed diameter) may be larger relative to head size than conventional crimpers. This further improves clearance for odd-shaped or long-drop terminations.

Various types of dies or die sets can be utilized with the inventive apparatus. A preferred die set is one that may be installed and removed without actuating the crimper. An exemplary die set and associated die installation and removal tool is described in U.S. Provisional Patent Application 61/582,315 filed Dec. 31, 2011, titled “Die Changing Tool and System for Crimper” which is hereby incorporated herein by reference in its entirety and is described herein. Die change-out can therefore be simple and quick.

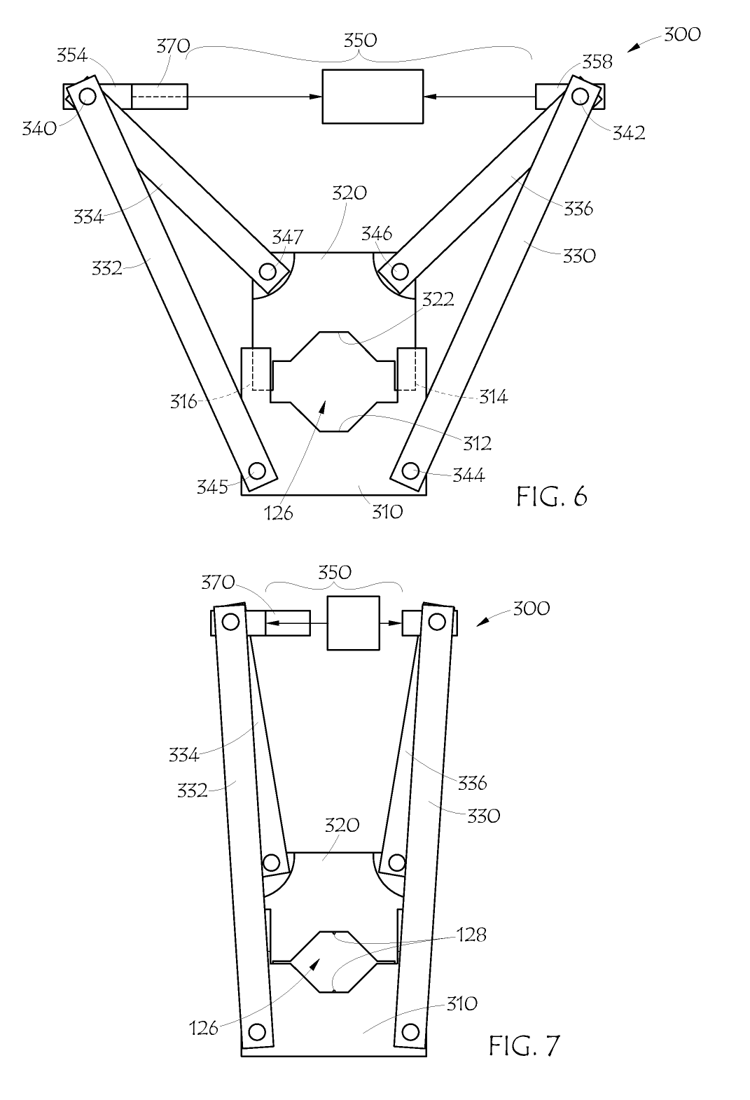

FIG. 6 illustrates crimper apparatus 300, a first embodiment of the present invention in the open position, and FIG. 7 illustrates the same embodiment in the closed or crimping position. The three main features of this embodiment of the invention are: (1) a crimper frame comprising a head and a base which can house the crimper dies; (2) a system of levers and linkages which can be actuated to drive the head and base together in a crimping motion; and (3) a drive mechanism to actuate the linkage. In FIGS. 6 and 7, crimper head 320 is slidably engaged with base 310, defining a polygonal-shaped opening in the resulting frame which is crimp zone 126. As will be seen later, sliders and dies may be mounted in the opening, further defining crimp zone 126. Head and base can slide together because of right frame slide mechanism 314 and left frame slide mechanism 316. The slide mechanism may be based on a channel and slider, or a post, or the like. Indicated in FIG. 6 is a slide mechanism (314 and 316) in which opposing side edges of head 320 slide in corresponding channels formed in base 310.

It should be understood that throughout this specification terms including left, right, upper, lower, front, rear, back, up and down are used for convenience referring to the perspective of a viewer of the drawing. These terms and the drawings are not intended to limit the possible orientation of the invention in any way, and it should be understood that the invention could be practiced in any orientation desired. Likewise, the terms inner, outer, axial, and radial are used for convenience, and are used relative to the axis of a tubular article (not shown) inserted at the center axis of crimp zone 126 or 126a or 126b in the respective figures. “Inner” means facing toward or located closer to the center axis of the crimp zone and “outer” means facing away from or located farther from the center axis of the crimp zone.

Also part of the frame are upper carriage 322 and lower carriage 312, which are mounted on or formed as an integral part of head 320 and base 310, respectively. These two carriages each have an inner horizontal central surface and two side surfaces angled at 135° with respect to the central surface. Thus, each carriage defines three bordering sides of the polygonal-shaped crimper zone 126. The carriages are adapted to carry or cradle sliders which will be described in more detail later. The central flat surfaces of each carriage may be equipped with pins 128 or other means to locate or mount a fixed slider thereon.

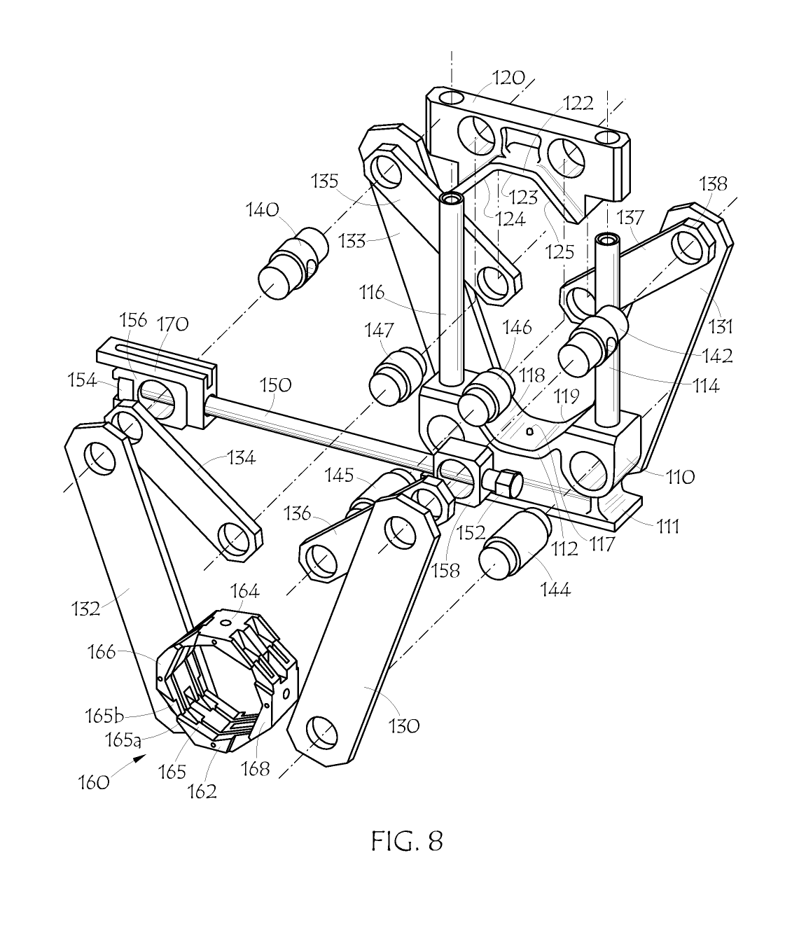

FIG. 6 shows the frame in the open position and FIG. 7 shows the frame in the closed position. In the open position, the polygonal space defined between upper carriage 322 and lower carriage 312 is eight-sided, with the left and right sides thereof being open space. In the closed position shown in FIG. 8, the polygonal space defined between upper carriage 322 and lower carriage 312 is six-sided. This completes the description of the crimper frame. There is also a sense in which the upper and lower carriages define a square, because there are four angled contact surfaces against which sliders slide.

The second main feature of the invention is a means of leverage to apply mechanical advantage to the crimp head to move it toward the base normal to the axis of the crimping action. The means of applying mechanical advantage to crimping apparatus 300 is a dual (one on the left side and one on the right side) compound leverage device consisting on the left side of left compression arm 334, left tension arm 332 pinned together at left elbow (or pivot joint) 340, and consisting on the right side of right compression arm 336, right tension arm 330 pinned together at right elbow (or pivot joint) 342. The end of the left compression arm 334 opposite left elbow 340 is attached to head 320 at left head pivot 347, while the end of the left tension arm 332 opposite left elbow 340 is attached to base 310 at left base pivot 345. Likewise, the end of the right compression arm 336 opposite right elbow 342 is attached to head 320 at right head pivot 346, while the end of the right tension arm 330 opposite right elbow 342 is attached to base 310 at right base pivot 344. The tension arms 330 and 332 are longer than the compression arms 334 and 336 and sized for proper actuation or motion of the head toward the base as the opposing elbows 340 and 342 are moved toward each other. Also the arms are sized so that mechanical advantage increases as the arms move toward an over-center position as shown in the closed position of FIG. 7.

The third main feature of the invention is the driver used to move the left and right elbows towards each other. In FIGS. 6 and 7, drive mechanism 350 is indicated generically, since a variety of possible mechanisms may be employed. Drive mechanism 350 is connected to the left and right elbows by means of left elbow drive connection 354 and right elbow drive connection 358. By way of example, drive mechanism 350 could be a pneumatic or hydraulic cylinder arranged to pull the elbows together for crimping, as indicated by the arrows in FIG. 6, and to push them apart for removing crimped articles, as indicated by the arrows in FIG. 7. Alternately, drive mechanism 350 could be a screw with a drive head such as a hex head or hex socket. The screw could cooperate with threads in one or both drive connections so that the desired motion is achieved when the screw is turned. An advantage of a screw mechanism is that it may be used to provide even more mechanical advantage. Thus, the inventive crimper can be screw-driven and actuated by an ordinary drill or air wrench for a portable embodiment. Alternately, the crimper system could include a hydraulic or pneumatic drive system or an electric motor drive system. Alternately, the driver could be extension arms to increase leverage sufficiently for manual operation. Combinations of driver mechanisms could be used.

Also shown is optional stop mechanism 370, which may also be of a number of different possible designs. The stop mechanism functions to limit the travel of the crimp head, thus setting the crimp diameter and preventing under- or over-crimped articles. Preferably the stop mechanism is adjustable for different crimp settings. Crimp diameter could be controlled electronically if crimper actuation were by hydraulics or by electric motor. Embodiments described herein utilize a hard stop that can be adjusted. Several possible hard stop designs will be described herein.

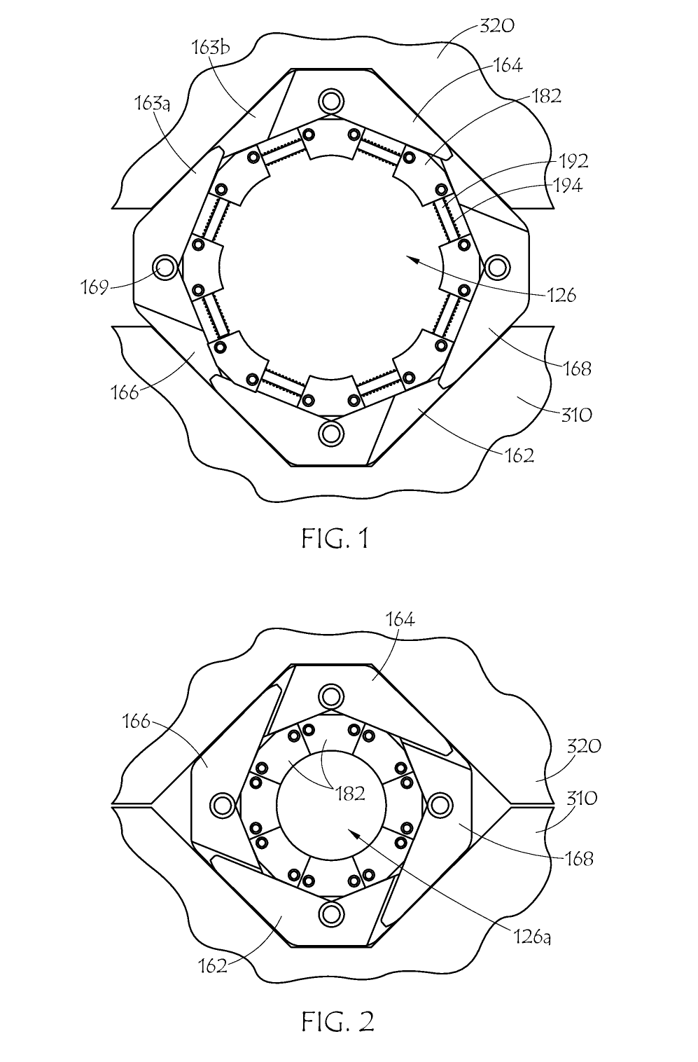

Not shown in FIGS. 6 and 7 are the additional die parts and mounts needed to complete the crimper apparatus. Any suitable style of die and die-mounting means could be used in the inventive crimper apparatus. One advantageous style is a set of linked dies mounted on sliders which are in turn mounted in the crimper apparatus. FIGS. 1-5 illustrate one possible design of the dies and sliders which may be advantageously used in the crimpers described herein.

The crimper die system illustrated in FIGS. 1-5 includes eight dies 182, mounted on four sliders 162, 164, 166, and 168, mounted in turn within crimper base 310 and crimper head 320. Lower slider 162 may be attached onto base 310, and upper slider 164 may be attached to upper head 320, using for example slider mounting pins 128 and mating holes on the sliders. Left slider 166 and right slider 168 are mounted so that they are free to slide against the angled surfaces of upper carriage 322 and lower carriage 312. The inner surfaces of the crimper carriages, which contact the sliders, define a regular convex polygonal shape, although missing two sides, into which the sliders fit. The outer surfaces of the sliders likewise define the polygonal shape, in this embodiment an octagon, but which could be a square or diamond. The inner surfaces of the sliders also define a regular polygonal shape, again in this case, an octagon. The inner octagon defined by the sliders is rotated in orientation with respect to the outer octagon of the sliders. The angle of rotation is half the included angle of a side, which is 22.5° for an octagon.

The crimper dies and sliders illustrated are of a special inventive design. The dies nest in the corners or vertices of the inner polygon defined by sliders 162, 164, 166, and 168. Thus, each die 182 has an outer surface that includes two outer surfaces 186a and 186b angled to match the interior angle of the sliders. Each slider advantageously may include a set of fingers 163a and 163b which mesh with the fingers of each other neighboring slider. FIG. 1 shows a crimper with base 310 and head 320 in the fully open position. Crimp zone 126 is at its maximum size, defining the largest object which could be inserted in the crimper for crimping. FIG. 2 shows a crimper with crimper base 310 and head 320 in the fully closed position. Crimp zone 126a is at its minimum size, defining the smallest crimp diameter possible with this particular combination of crimper and die set. As the crimper heads are brought together, from the open position of FIG. 1 to the closed position of FIG. 2, the sliders may intermesh for maximizing the range of crimp diameters possible. In other words, the fingers allow for a larger maximum open diameter by supporting four of the dies in the open position. The fingers allow for a smaller minimum closed diameter by intermeshing as the sliders come together. Thus, the sliders may intermesh in a shutter-like pattern as illustrated in FIG. 2. The sliders thus define a polygon with half of its vertices permanently formed in the middle of a slider and the other half defined by the intersection of the intermeshing fingers on two adjacent sliders. As a result, the lengths of all sides of the polygon remain equal as their lengths change due to motion of the crimper heads. Also, the dies remain equally spaced and on a circle as the circle diameter changes due to motion of the crimper heads.

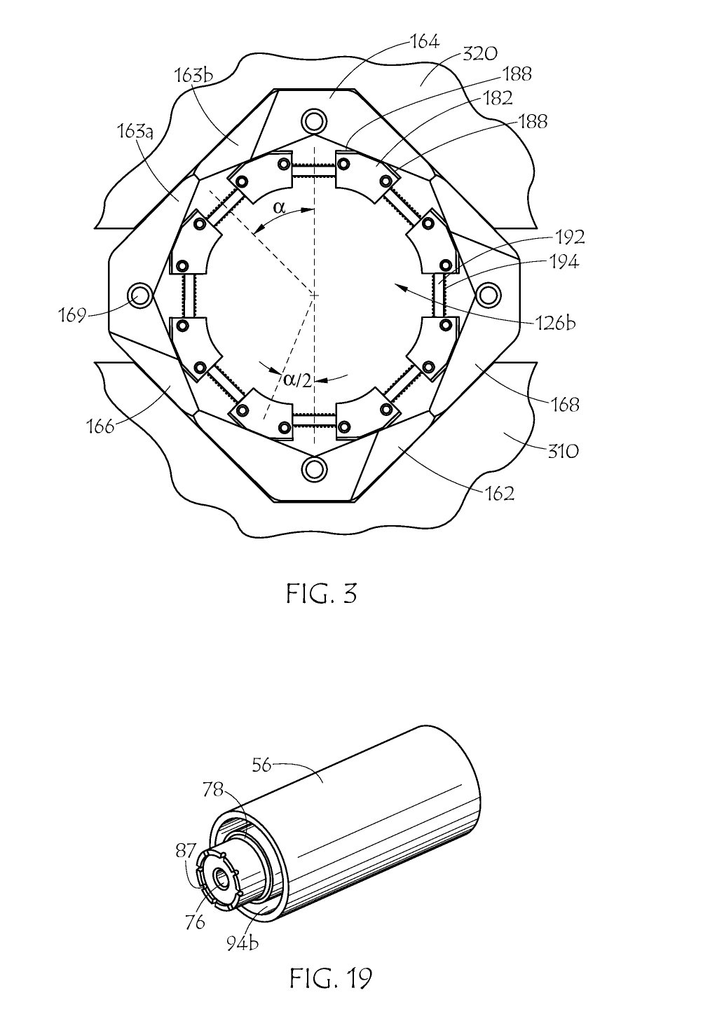

In the die set embodiment illustrated herein, the outer surface of each die has a projection that engages in a groove in the slider. As the die set is rotated, so that each die moves away from its natural position in a corner of the polygon defined by the sliders, the dies move radially inward. This motion disengages each projection from the groove at least by the time the die is positioned in the center of a side of the polygon defined by the sliders, which is the position of maximum inner radial movement. FIG. 3 shows dies 182 of FIGS. 1 and 2 in the position of maximum rotation with respect to sliders 162, 164, 166, 168. In the case of the octagon-based system shown, the included angle, a, of a side of the polygon is 45°, so the angle of maximum rotation, α/2, is 22.5°. In this position, projections 188 no longer engage the grooves on the sliders, and the die set can be slid in or out of the crimper.

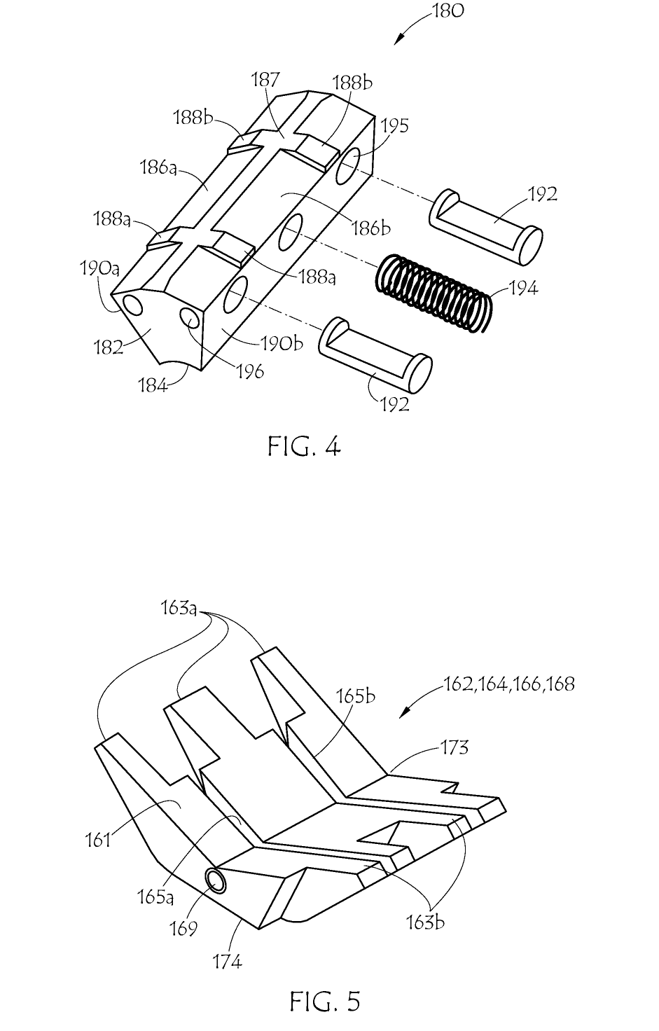

The details of an embodiment of a suitable crimper die are shown in FIG. 4 and the details of an embodiment of a suitable slider are shown in FIG. 5. Die 180 has inner face 184 which is the crimp face that actually contacts the object to be crimped. Side faces 190a and 190b are angled toward each so that when the full set of dies are in the fully closed position, the dies form a desired crimp shape, in this case a circle or cylinder. The outer surfaces 186a and 186b, as mentioned above, are angled so as to fit the polygon defined by the sliders, which in this case is an octagon. The dies have two projections 188a and 188b which fit in two slider grooves 165a and 165b as seen in FIG. 5. The corner that would have been defined by outer surfaces 186a and 186b is beveled or formed as flat surface 187. Likewise portions of projections 188a and 188b are beveled or formed as part of flat surface 187 so that no portion of the die or the projections extends outward past flat surface 187. This ensures that the dies will slide axially into and out of the sliders when oriented with flat surface 187 parallel to slider inner surface 161. FIG. 3 shows the dies oriented in such a position for removal and installation from the sliders. The dies' flat surfaces 187 provide stability to the dies when oriented for removal. Without the flat surfaces, the dies would be unstable and tend to tip over or rotate as soon as they are moved away from the corner positions.

FIG. 5 illustrates details of a slider with which the inventive die set and crimper system can be used. The inner surface 161 of slider 162, 164, 166, 168 comprises two sides of a polygon, in this case an octagon, and forms corner 173 in which a die may nest as described above. There is recess or hole 169 in front face 174 of slider 162, 164, 166, 168 for engaging the installation tool as will be described in more detail below. This slider has two slots or grooves 165a and 165b. When the complete set of sliders is arranged in a crimper, the grooves align forming a groove around the entire inner periphery of the polygonal opening. One or both of these grooves may house a circular leaf spring or wire spring which may bias the four sliders outward against the crimper heads. The spring or springs may therefore retain the sliders in the crimper independently of the die set and without need for other fastening means. The grooves 165a and 165b may also be used to capture the die set via projections such as 188a and 188b on dies 182.

Die connectors according to one possible embodiment of the invention are shown in FIG. 4. According to this embodiment, the die connector includes die spring 194 and two connecting rods 192. Die 180 includes three ports 195 on each wedge face or side face 190a and 190b. The middle port houses one end of spring 194 in such a way that the spring may bias the die outward for retaining in the crimper. In addition, spring 194 may be completely housed within the port when the dies are collapsed together in the fully closed position shown in FIG. 2. Connecting rods 192 are slidably engaged by set screws (not shown) within the front and rear ports 195. The set screws may be installed in the corresponding screw holes 196 on the end face 182 of die 180. Connecting rods 192 thus limit the expansion of the die set, hold the die set together when removed from the crimper, and retract into the ports when the die set is in the fully closed position. The connectors do not interfere with the closing of the crimper. Other arrangements are possible, including more than one spring, different numbers of connecting rods, and the like. A connector rod may be combined with a spring and share a suitably designed port. What is important is that the die connectors provide the functions of biasing the die set outward, limiting the expansion of the die set, and not interfering with the closure of the die set.

The above has described a type of die set and crimper system with which the inventive crimper apparatus may be used. The die set described may also be used with one or more embodiments of the die set installation and removal tool and processes described in a U.S. Provisional Patent Application 61/582,315 filed Dec. 31, 2011, titled “Die Changing Tool and System for Crimper”, the entire contents of which are hereby incorporated herein by reference and described herein. The die removal process includes inserting a die rotator as described herein into the spaces between adjacent pairs of dies in an interconnected set of crimper dies which are mounted in a crimper; rotating the set of crimper dies by turning a handle attached to the die rotator; engaging at least one detent on the die rotator with at least one die connector; and pulling the set of crimper dies out of the crimper and into a can that is slidably mounted between the die rotator and the handle. The process of rotating the die set causes each of the crimper dies to disengage from its mount in the crimper, thus permitting free axial motion relative to the crimper. Then the die set is simply pulled out of the crimper.

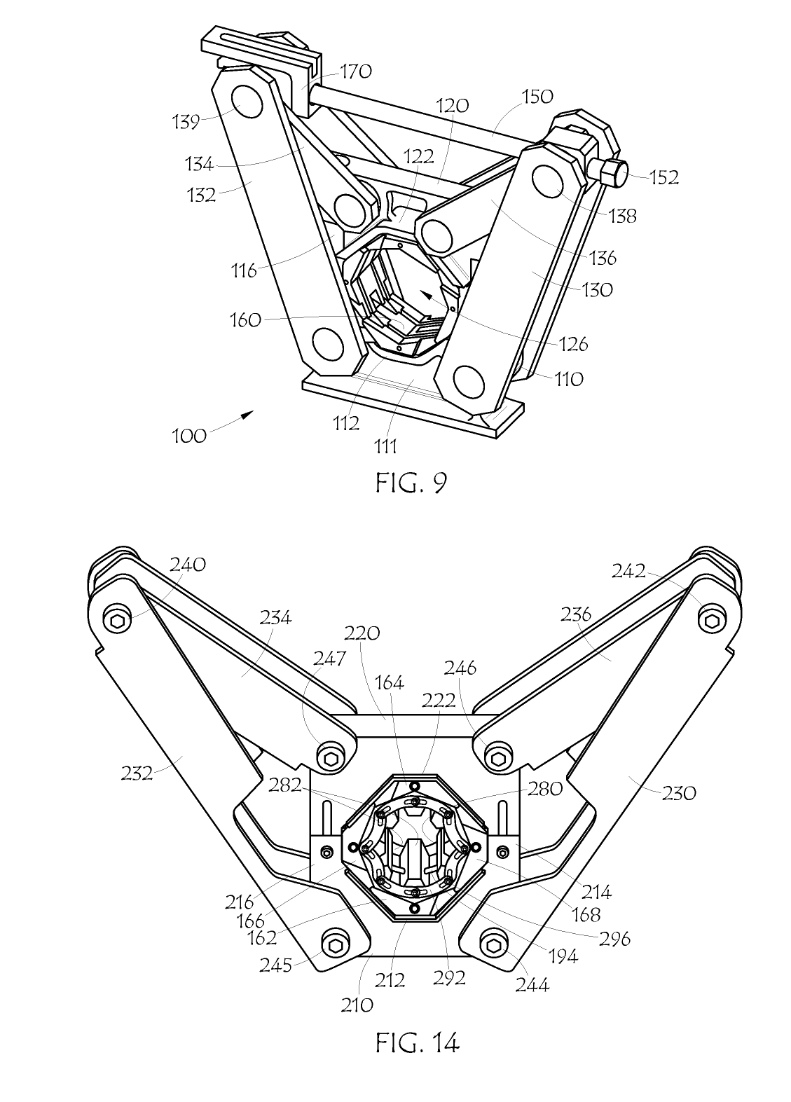

FIGS. 8 and 9 show a second embodiment of a crimper apparatus according to the invention. FIG. 8 illustrates crimper apparatus 100 in an exploded perspective view, and FIG. 9 illustrates the same embodiment assembled. The second embodiment of FIGS. 8 and 9 includes a crimper frame, a leverage mechanism, a drive mechanism and an associated stop mechanism. The sliders described above are also shown in FIGS. 8 and 9.

Referring now to FIGS. 8 and 9, crimper frame 110 includes base 111, two vertical frame posts, right frame post 114 and left frame post 116, mounted thereon on either side of crimper base 111. Movable crimper head 120 has two vertical holes so that it can slide over frame posts 114 and 116. Thus, head 120 is slidably engaged with base 111, defining a polygonal-shaped opening in the resulting frame which is crimp zone 126. As will be seen later, sliders and dies may be mounted in crimp zone 126. Head 120 and base 111 can slide together.

Also part of the frame are upper carriage 122 and lower carriage 112, which are mounted on or formed as an integral part of head 120 and base 111, respectively. The lower carriage has upward-facing, horizontal, central surface 117 and two adjacent side surfaces 118 and 199 each angled upward at 135° with respect to central surface 117. The upper carriage 122 has downward-facing, horizontal, central surface 123 and two adjacent side surfaces 124 and 125 angled downward at 135° with respect to the central surface. Thus, each carriage defines three bordering sides of the polygonal-shaped crimper zone 126. The carriages are adapted to carry sliders 162, 164, 166, and 168 as described above. The central flat surfaces of each carriage may be equipped with pins or other means to locate or mount a fixed slider thereon. A circular spring may be used to bias the sliders outward against the carriages to retain them in position.

The means of applying mechanical advantage to crimping apparatus 100 is again a dual (one on the left side and one on the right side) compound leverage device. However, in this embodiment the levers all consist of matched pairs of arms (front and rear arms), which combined make up the left and right compound lever arms. Thus, on the left side of the apparatus are left front compression arm 134, left rear compression arm 135, left front tension arm 132, and left rear tension arm 133. The arms are joined together at left elbow 139 with pivot joint 140, which is a cylindrical axle with shoulders adapted to maintain the desired spacing between front and rear arms. Likewise, on the right side are right front compression arm 136, right rear compression arm 137, right front tension arm 130, and right rear tension arm 131, joined together at right elbow 138 with pivot joint 142. The ends of left compression arms 134 and 135 opposite left elbow 140 are attached to head 120 at left head pivot 147, which is another cylindrical axle suitably adapted for the purpose. The end of left tension arms 132 and 133 opposite left elbow 140 are attached to base 111 at left base pivot 145. Likewise, the ends of right compression arms 130 and 131 opposite right elbow 142 are attached to head 120 at right head pivot 146, while the ends of right tension arms 130 and 131 opposite right elbow 142 are attached to base 111 at right base pivot 144. The tension arms 130, 131, 132, and 133 are longer than the compression arms 134, 135, 136, and 137 and sized for proper actuation or motion of the head toward the base as the opposing elbows 138 and 139 (via joints 140 and 142) are moved toward each other. Also, the arms are sized so that mechanical advantage increases as the arms move toward an over-center position analogous to the closed position shown for the previous embodiment in FIG. 7.

The driver used to move the left and right elbows towards each other in the second embodiment of FIGS. 8 and 9 is drive screw 150, with drive nut 152 which may be a hex head adapted for driving with a socket on a drill/driver or similar device, and with take-up nut 154 on the opposite end of screw 150 from drive nut 152. Drive screw 150 is connected to the left and right elbows by means of left elbow drive connection 156 and right elbow drive connection 158. It should be understood that alternate drive mechanisms could be used as described above in connection with the embodiment of FIGS. 6 and 7.

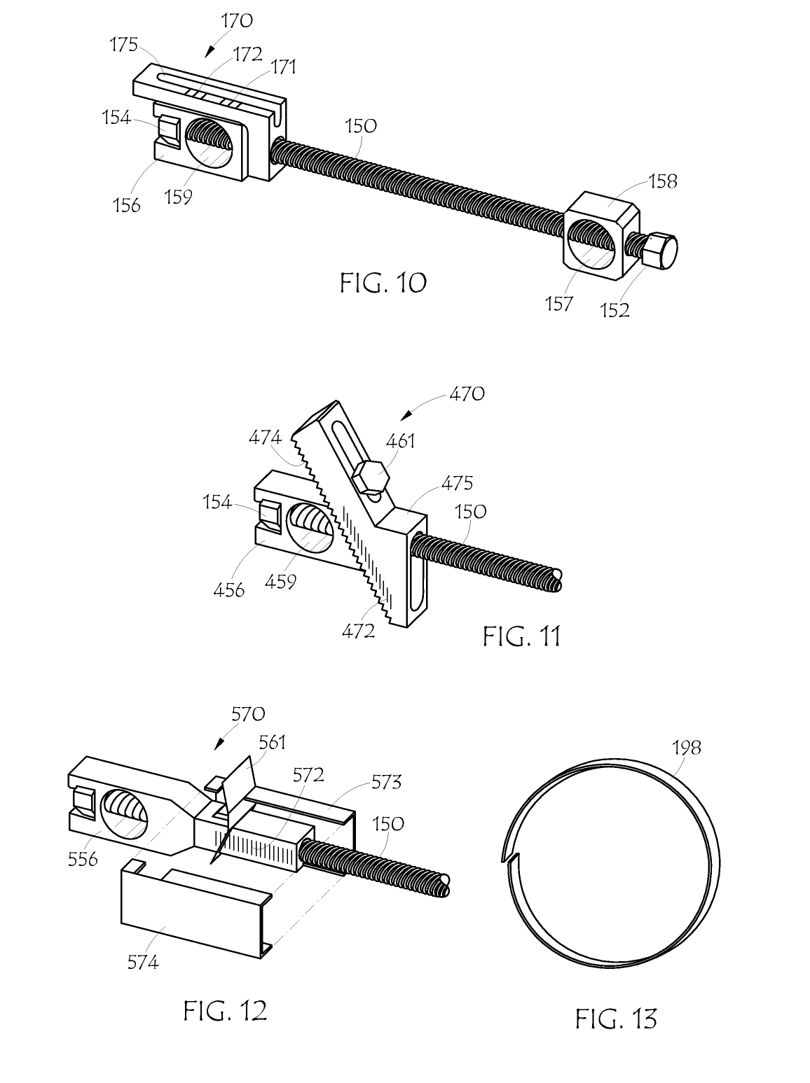

Also shown with the second embodiment of FIGS. 8 and 9 is optional adjustable stop mechanism 170. Drive screw 150 and stop mechanism 170 are shown in more detail in FIG. 10. Right elbow drive connection 158 includes pivot housing 157 for right pivot joint 142. On the left end, left elbow drive connection 156 includes take-up pivot housing 159 for left pivot joint 140 and take-up nut 154. Also mounted on drive connection 156 is adjustable stop member 175 which is attached by means of lock nut 171, and which includes a calibrated scale 172. Scale 172 may be marked off in uniform increments of length, which may then be correlated with give die sets and hose couplings to reproducibly produce desired crimp diameters. Alternately, the scale may be calibrated for various standard coupling sizes which need not be uniformly spaced. It may also be convenient or necessary to include a secondary calibration means for the case where the increments between marks are relatively correct, but the entire scale needs to be shifted. Such a secondary calibration may be provided by a secondary stop which may also be adjustable and may be as simple as a washer, spacer, shim or lock nut mounted on screw 150.

The second embodiment of FIGS. 8 and 9 shows die cage 160 formed by four sliders 162, 164, 166, and 168, mounted within crimper frame 110. Lower slider 162 is attached onto surface 117 on fixed lower carriage 112 on base 111, and upper slider 164 is attached to surface 123 on upper carriage 122 on movable upper head 120. Left slider 166 and right slider 168 are mounted so that they are free to slide against the angled surfaces 124 and 125 of upper carriage 122 and surfaces 118 and 119 of lower carriage 312, respectively. The movement of the head towards the base thus causes left slider 166 and right slider 168 to move towards each other, i.e. inward toward the central axis of the crimp zone. As the sliders move inward, the fingers 163a and 163b mesh together. When the head moves upward away from the base, the left slider 166 and right slider 168 are caused to move outward by a circular spring present in the groove 165, or two springs in two grooves 165a and 165b (shown in FIG. 5). An exemplary circular spring 198 is shown in FIG. 13. Die cage 160 can thus house a die set such as described above and shown in FIGS. 1-4.

Some alternative hard stop designs for the crimper drive mechanism will now be described as shown in FIGS. 11 and 12. In both embodiments of FIGS. 11 and 12 the drive mechanism is based on drive screw 150, but the adjustable stop mechanisms are different. In the embodiment of FIG. 11 the drive mechanism is based on drive screw 150. In FIG. 11, adjustable stop mechanism 470 includes on the left end, left elbow drive connection 456 which includes take-up pivot housing 459 for a left pivot joint (see e.g. left elbow 139 and pivot joint 140 in FIGS. 8, 9 and 24) and take-up nut 154. Mounted on drive connection 456 is adjustable stop member 475 which is attached by means of lock nut 461. Drive connection 456 corresponds to the first special bushing which is described in more detail below. The interface between drive connection 456 and stop member 475 is cut at an angle with respect to screw 150 and the corresponding surfaces of connection 456 and stop member 475 are given serrations or steps 474 so that they may engage at a great number of possible stop positions. Lock nut 461 passes through a slotted hole in stop member 475 to screw into drive connection 456 thus holding the stop member in any desired position. At least one of the drive connection and the stop member includes a calibrated scale 472. For identifying the position of the stop. Scale 472 may be marked off in uniform increments of length, which may then be correlated with given die sets and hose couplings to reproducibly produce desired crimp diameters. Alternately, the scale may be calibrated for various standard coupling sizes which need not be uniformly spaced. It may also be convenient or necessary to include a secondary calibration means for the case where the increments between marks are relatively correct, but the entire scale needs to be shifted. Such a secondary calibration may be provided by a secondary stop which may also be adjustable and may be as simple as a washer or shim or lock nut mounted on screw 150. Such a stepped stop or setting mechanism for a crimper is further described below and also in U.S. Provisional Patent Application 61/582,317, filed Dec. 31, 2011 and titled “Stepped Crimp Setting for Screw-Operated Crimper” the entire contents of which are hereby incorporated herein by reference.

The adjustable stop mechanism 570 shown in FIG. 12 includes screw drive 150 and drive connection 556 which are analogous in function to the corresponding parts in FIG. 10 and FIG. 11. The adjustable stop member includes stop housing 573 and 574, in two halves. Drive connection 556 includes an extended portion with notches 572. Screw 150 passes through the extended portion. The extended portion extends into stop housing 573 and 574. Also within housing 573 and 574 is a stop spring and ratchet 561. The spring biases the ratchet to remain engaged with a chosen serration on extended portion 572 of drive connection 556. A portion of ratchet 561 protrudes from the housing so that a user can disengage the ratchet and adjust the stop housing for a chosen setting. A scale may included on stop mechanism and a secondary stop utilized as in the other embodiments.

In the case where any of the aforementioned adjustable stops cannot be lengthened enough to stop at the appropriate crimp diameter, a spacer (not shown) may be used to effectively increase its length. A set of spacers may be provided to accommodate various crimp diameters. Several methods of setting crimp diameter may be useful for a screw-operated crimper, including a long nut with screw, a releasable nut for quick adjust, a ratcheting rod similar to a bar clamp, replaceable spacers, and attached spacers. All of these methods are a means to create a positive stop for a lead screw that drives a screw-operated crimper or for other drive means for the inventive crimper system.

The second embodiment of the crimper apparatus shown in FIGS. 8 and 9, having balanced front and rear arms may be a more balanced, smoother operating design than the first embodiment shown in FIGS. 6 and 7. However, the second embodiment has more parts to manufacture and more complicated joints, leading the first embodiment to be cheaper to produce. A third embodiment is shown in FIG. 14 which includes some of the advantages of both the first and second embodiments. The arms in FIG. 14 are formed of single pieces of metal or other suitable materials, resulting in fewer parts. However, the arms are U-shaped channels which result in front and rear connections on the base and head which are again very balanced.

Referring to the embodiment of FIG. 14, the crimper apparatus has two opposing crimper heads, upper head 220 and lower head 210. The two heads are adapted to slide together using slots in one and bolts in the other. The two heads are made of U-shaped material adapted so one head fits into the other. Left slide mechanism 216 and right slider mechanism 214 perform the same function as the posts and slide holes of the second embodiment or as the slider and channel of the first embodiment. The two heads, in the open position shown in FIG. 14 define an eight-sided opening formed therein. The upper head includes upper carriage 222, and the lower head includes lower carriage 212, each of which includes a central flat surface and two angled surfaces which together account for six of the eight sides of the aforementioned opening. The carriages house four sliders 162, 164, 166, and 168 as described previously for the other embodiments. The sliders again have a slot or two in which resides one or more circular spring biasing the sliders outward against the carriages. The outer perimeter of the four sliders again describes an octagon shape, and the inner perimeter of the sliders defines an octagon that is rotated 22.5° with respect to the outer octagon. In the corners of the inner octagon defined by the sliders sits die set 280 consisting of eight dies 282 that are linked together with connectors 292 and springs 194. The die connectors are mounted on the front and rear end faces of the dies with bolts 296. The die connectors are slotted and the springs are housed in recesses so that the dies can freely move together to perform a crimp. Each die 282 also has a protrusion or protrusions on its outer surface to engage the slot or slots in the sliders, such as described previously.

The third embodiment shown in FIG. 14 has a leverage mechanism analogous to the first and second embodiments. The arms are made of U-shaped channels which are sized to fit over the other parts wherever they are joined together. The means of applying mechanical advantage to the third crimping apparatus is a dual (one on the left side and one on the right side) compound leverage device consisting on the left side of left compression arm 234, left tension arm 232 bolted together at left elbow (or pivot joint) 240, and consisting on the right side of right compression arm 236, right tension arm 230 pinned together at right elbow (or pivot joint) 242. The end of the left compression arm 234 opposite left elbow 240 is attached to upper head 220 at left upper head pivot 247, while the end of the left tension arm 232 opposite left elbow 240 is attached to lower head 210 at left lower head pivot 245. Likewise, the end of the right compression arm 236 opposite right elbow 242 is attached to upper head 220 at right upper head pivot 246, while the end of the right tension arm 230 opposite right elbow 242 is attached to lower head 210 at right lower head pivot 244. The tension arms 230 and 232 are longer than the compression arms 234 and 236 and sized for proper actuation or motion of the two heads toward each other as the opposing elbows 240 and 242 are moved toward each other. Also, the arms are sized so that mechanical advantage increases as the arms move toward an over-center position as was shown previously in the closed crimper position in FIG. 7.

The driver mechanism is not shown in FIG. 14, but may be any of the aforementioned driver mechanisms, or the crimper may be actuated by hand without further driver mechanisms. Thus, any suitable mechanism may be used, such as a hydraulic press, a screw, and/or a lever mechanism, or the like.

Thus various embodiments of the invention may have a number of advantageous features. Sliders may be used which create a varying-sized regular polygon shape throughout the range of crimp. A set of sliders may extend into each other in such a way that as they slide together, a regular polygon shape is maintained throughout the range of crimp. Die segments may be located at each point of this polygon and may be forced radially inward during crimping. The sliders may include one or more slots containing a leaf spring or wire spring which holds the sliders in place against the crimp head. Such a slot may also be used to capture the die set via a protrusion on the dies. The die retention method may allow insertion and removal via a die set rotation.

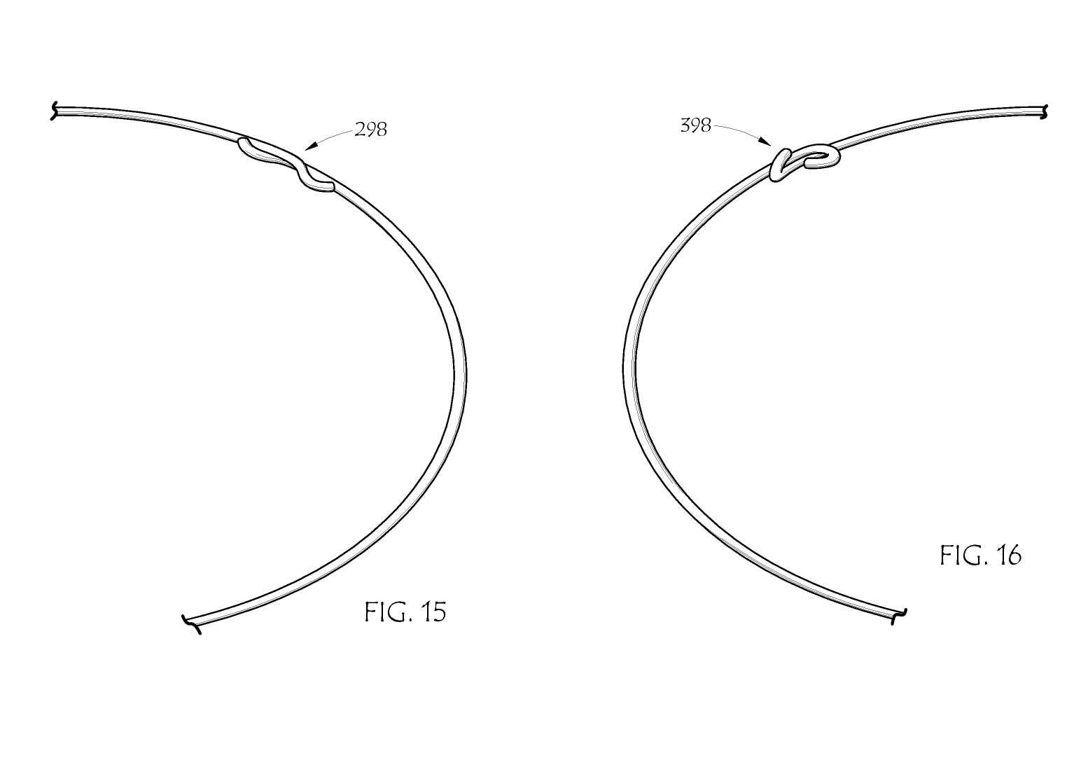

The wire spring used to hold sliders in place may be fabricated so that its ends are supported and slide along the wire. The wire spring may have ends that are bent over to ride on the adjacent wire as shown for wire spring 298 in FIG. 15 or for wire spring 398 in FIG. 16. This keeps the ends of the spring in place so they don't bind as they are pushed around the circle within the slider slots 165. In either embodiment of the spring, the circular spring acts over 360° throughout a large diameter range.

In an embodiment of a crimper apparatus, both the crimp head and the arms may be made of steel plate. The various configurations provide stability and strength, but reduced weight because many parts are essentially hollow. The efficiency of the load-bearing construction also contributes to lighter weight in the overall design.

The power source can also be small, light and inexpensive—such as an electric drill, air wrench, or a low-power motor connected to the crimper. This device should therefore be lower cost, lighter weight and more mobile than devices of equivalent crimp capacity in the market today.

Die segments in the die sets are advantageously sprung outward via compression springs and ganged together via ties or connectors. Ties may consist of pins with a recessed portion in the middle. This recess can move freely past a pin or screw, which keeps the tie from coming out. The advantage of this method is that it is a compact way of tying the segments together without sacrificing crimp clearance. Fabricating the die segments is relatively simple because they consist of a general shape with various holes in it.

To retain the die set within the sliders, protrusions of a unique shape may be used such that when die segments are rotated, protrusions move inward and are no longer captured by the sliders because of a flat. In the rotated position, the die set will readily slide out of the crimp head, making it easy to replace one die set with another.

Although the three embodiments shown herein may be most advantageous for mobile or portable crimping applications, the concepts are scalable and applicable to larger, fixed devices. There is increased flexibility in how the device is powered since there can be a longer stroke with less force. The crimping device could be oriented any number of ways, such as with the drive screw on the bottom or side, or with the axis of the crimp vertical rather than horizontal, etc. Arms could be extended—potentially even to the point where human strength can pull a lever to crimp.

The apparatus may include a keyed upper screw pin hole to prevent screw wear and binding.

The inventive systems and methods for removal and installation of crimper die sets are designed to work with a crimper in its open position, and without any operation of the crimper during removal or installation of the die set. The systems and methods work with crimpers which utilize a set of sliders which define a polygonal opening and with die sets in which a die normally sits in each vertex of the polygonal opening. The die change tool is used to rotate the die set as a unit within the crimper. Upon rotation, the dies disengage from their supporting sliders and engage with the die change tool. Then the die set may be withdrawn from the crimper into a can. From their position in the can of the die change tool, the dies may be stored or reinstalled into the crimper by reversing the process.

FIGS. 1-5 illustrate a crimper die system particularly suited for use of the inventive die change tool. The system includes eight dies 182, mounted on four sliders 162, 164, 166, and 168, mounted in turn within two crimper heads 310 and 320. Not shown is the mechanism used to force the two crimper heads together. Any suitable mechanism may be used, such as a hydraulic press, a screw, and/or a lever mechanism, or the like. Lower slider 162 may be attached onto lower head 310, and upper slider 164 may be attached to upper head 320. Left slider 166 and right slider 168 are mounted so that they are free to slide against the angled surfaces of the heads. The inner surfaces of the crimper heads, which contact the sliders, define a regular convex polygonal shape, although missing two sides, into which the sliders fit. The outer surfaces of the sliders likewise define the polygonal shape, in this embodiment an octagon. The inner surfaces of the sliders also define a regular polygonal shape, again in this case, an octagon. The inner octagon defined by the sliders is rotated in orientation with respect to the outer octagon of the sliders. The angle of rotation is half the included angle of a side, which is 22.5° for an octagon.

It should be understood that the terms lower, upper, front, rear, left, and right are used for convenience with respect to the orientation of the figures as viewed by the reader. These terms are not meant to restrict the invention to any particular orientation of any crimper or crimper system. Likewise the terms inner, outer, axial, and radial are used for convenience, and are used relative to the axis of a tubular article (not shown) inserted at the center axis of crimp zone 126 or 126a or 126b in the respective figures. “Inner” means facing toward the center axis of the crimp zone and “outer” means facing away from the center axis of the crimp zone.

The crimper dies and sliders illustrated are of a special inventive design. The dies nest in the corners or vertices of the inner polygon defined by the sliders. Thus, each die 182 has an outer surface that includes two outer surfaces 186a and 186b angled to match the interior angle of the sliders. Each slider advantageously may include a set of fingers 163a and 163b which mesh with the fingers of each other slider. FIG. 1 shows a crimper with crimper heads 310 and 320 in the fully open position. Crimp zone 126 is at its maximum size, defining the largest object which could be inserted in the crimper for crimping. FIG. 2 shows a crimper with crimper heads 310 and 320 in the fully closed position. Crimp zone 126a is at its minimum size, defining the smallest crimp diameter possible with this particular combination of crimper and die set. As the crimper heads are brought together, from the open position of FIG. 1 to the closed position of FIG. 2, the sliders may intermesh for maximizing the range of crimp diameters possible. In other words, the fingers allow for a larger maximum open diameter by supporting four of the dies in the open position. The fingers allow for a smaller minimum closed diameter by intermeshing as the sliders come together. Thus, the sliders may intermesh in a shutter-like pattern as illustrated in FIG. 2. The sliders thus define a polygon with half of its vertices permanently formed in the middle of a slider and the other half defined by the intersection of the intermeshing fingers on two adjacent sliders. As a result, the lengths of all sides of the polygon remain equal as their lengths change due to motion of the crimper heads. Also, the dies remain equally spaced and on a circle as the circle diameter changes due to motion of the crimper heads.

The inventive die change tool is designed to rotate the dies in order to disengage them from the sliders. Therefore the outer surface of the dies and the inner surface of the sliders must be specially designed. Generally, each die has a natural position seated in a corner of the polygon defined by the sliders and engaged to the sliders. As the die set is rotated, so that each die moves away from its natural position in a corner of the polygon toward the center of a side of the polygon, the dies must move radially inward, toward a partially closed position. This motion must disengage each die from the slider it was engaged to.

In the embodiment illustrated herein, the outer surface of each die has a projection that engages in a groove in the slider. As the die set is rotated, so that each die moves away from its natural position in a corner of the polygon defined by the sliders, the dies move radially inward. This motion disengages each projection from the groove at least by the time the die is positioned in the center of a side of the polygon defined by the sliders, which is the position of maximum inner radial movement. FIG. 3 shows dies 182 of FIGS. 1 and 2 in the position of maximum rotation with respect to sliders 162, 164, 166, 168. In the case of the octagon-based system shown, the included angle, a, of a side of the polygon is 45°, so the angle of maximum rotation, α/2, is 22.5°. In this position, projections 188 no longer engage the grooves on the sliders, and the die set can be slid in or out of the crimper.

The details of an embodiment of a suitable crimper die are shown in FIG. 4 and the details of an embodiment of a suitable slider are shown in FIG. 5. Die 180 has inner face 184 which is the crimp face that actually contacts the object to be crimped. Side faces 190a and 190b are angled toward each so that when the full set of dies are in the fully closed position, the dies form a desired crimp shape, in this case a circle or cylinder. The outer surfaces 186a and 186b, as mentioned above, are angled so as to fit the polygon defined by the sliders, which in this case is an octagon. The dies have two projections 188a and 188b which fit in two slider grooves 165a and 165b as seen in FIG. 5. The corner that would have been defined by outer surfaces 186a and 186b is beveled or formed as flat surface 187. Likewise portions of projections 188a and 188b are beveled or formed as part of flat surface 187 so that no portion of the die or the projections extends outward past flat surface 187. This ensures that the dies will slide axially into and out of the sliders when oriented with flat surface 187 parallel to slider inner surface 161. FIG. 3 shows the dies oriented in such a position for removal and installation from the sliders. The dies' flat surfaces 187 provide stability to the dies when oriented for removal. Without the flat surfaces, the dies would be unstable and tend to tip over or rotate as soon as they are moved away from the corner positions.

FIG. 5 illustrates details of a slider with which the inventive die change system can be used. The inner surface 161 of slider 162, 164, 166, 168 comprises two sides of a polygon, in this case an octagon, and forms corner 173 in which a die may nest as described above. There is recess or hole 169 in front face 174 of slider 162, 164, 166, 168 for engaging the installation tool as will be described in more detail below. This slider has two grooves 165a and 165b. When the complete set of sliders is arranged in a crimper, the grooves align forming a groove around the entire inner periphery of the polygonal opening. One or both of these grooves may house a circular leaf spring which may bias the four sliders outward against the crimper heads. The spring or springs may therefore retain the sliders in the crimper independently of the die set and without need for other fastening means.

Die connectors according to one possible embodiment of the invention are shown in FIG. 4. According to this embodiment, the die connector includes die spring 194 and two connecting rods 192. Die 180 includes three ports 195 on each wedge face or side face 190a and 190b. The middle port houses one end of spring 194 in such a way that the spring may bias the die outward for retaining in the crimper. In addition, spring 194 may be completely housed within the port when the dies are collapsed together in the fully closed position shown in FIG. 2. Connecting rods 192 are slidably engaged by set screws (not shown) within the front and rear ports 195. The set screws may be installed in the corresponding screw holes 196 on the end face 182 of die 180. Connecting rods 192 thus limit the expansion of the die set, hold the die set together when removed from the crimper, and retract into the ports when the die set is in the fully closed position. The connectors do not interfere with the closing of the crimper. Other arrangements are possible, including more than one spring, different numbers of connecting rods, and the like. A connector rod may be combined with a spring and share a suitably designed port. What is important is that the die connectors, provide the functions of biasing the die set outward, limiting the expansion of the die set, and not interfering with the closure of the die set.

The above has described a type of die set and crimper system for which the inventive die installation tool may be used. What follows describes embodiments of the die set installation and removal tool of the invention. FIGS. 6 and 7 show two embodiments of the inventive tool in exploded perspective view.

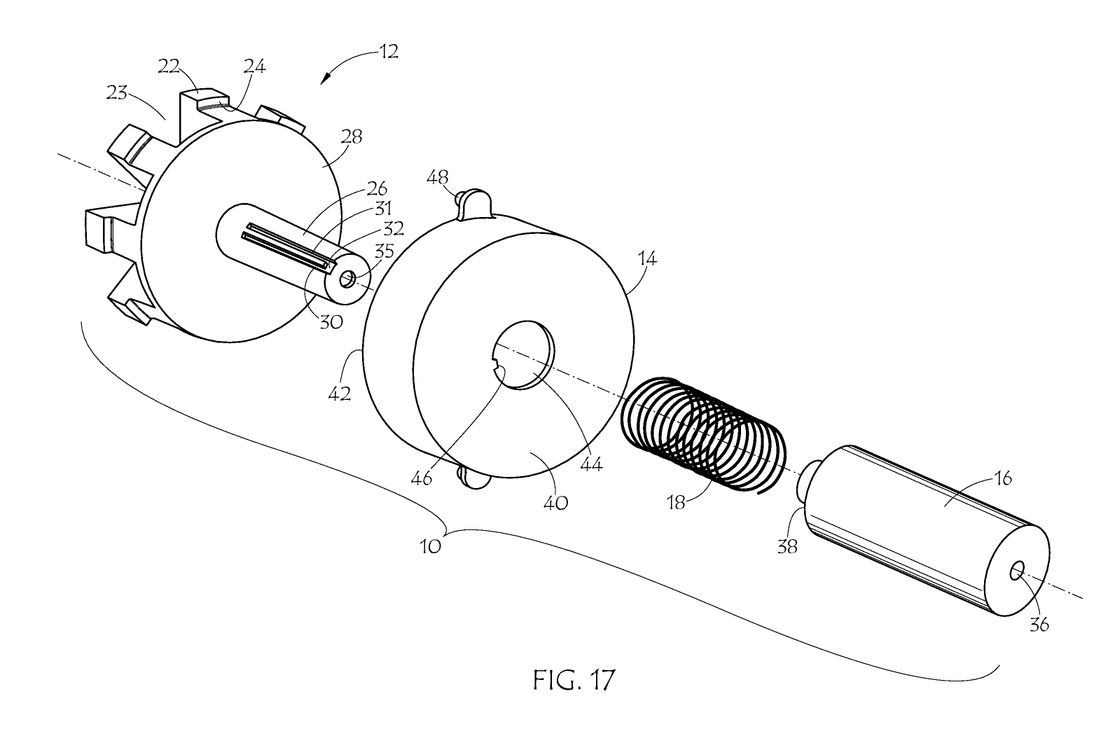

According to the embodiment of FIG. 17, die removal tool 10 for the installation and removal of interconnected die sets includes a handle assembly and can 14. The handle assembly includes handle 16 and die rotator 12, shown exploded. Handle 16 and die rotator 12 are fastened together, for example, by integral formation, by welding or gluing, or by using a bolt or other suitable fastener through holes 35 and 36. Die rotator 12 includes a plurality of legs 22 and spaces 23 extending radially in a regularly spaced fashion from the end of shaft 26. The size and spacing and number of legs is preferably chosen to match the die set. In one embodiment, the die set has eight dies and eight spaces between the dies, so the die rotator preferably has eight legs which fit the spaces between dies when the die is in the fully open position as shown in FIG. 1. The die rotator includes stop 28 to limit how far into the die set spaces the die legs can be inserted. Since the dies will occupy spaces 23, they will not be able to move past stop 28. Legs 22 include detents 24 which are adapted to engage with connectors 192 between the dies. When the detents engage the connectors, the tool will be able to pull the die set out of the crimper and into the can for further handling and/or storage. Detent 24 is in the form of a step, but other shapes that serve the purpose would be suitable.

Can 14 is slidably mounted on the handle assembly so that is can slide along shaft 26 of the die rotator/handle assembly. Thus, can 14 may have open end 42 and closed end 40, so that the die rotator can be housed within the can and be slide in and out of the open end of the can by manipulating the handle. A spring 18 may be used to bias the handle outward from the can and the die rotator into the open end of the can. The spring may be installed with suitable shoulder 38, for example, or with protective cover, housing, or other related features as desired. Can 14 may include at least one alignment guide feature to facilitate use of the tool with a given crimper. Can 14 thus has two alignment guides in the form of alignment pegs 48 which mate with alignment holes 169 in two opposing sliders. Alternate means of alignment are possible, for example, the can could be of polygonal shape and mate with a polygonal opening on the front of the crimper.

The tool may include means to limit the movement of the can along the handle assembly. In other words, if the can is held in alignment with the crimper, the tool may include means to limit the movement of the handle assembly. In the embodiment of FIG. 17, shaft 26 has a U-shaped channel or track which mates with guide protrusion 46 in opening 44 on the closed end 40 of can 14. The U-shaped channel includes legs 31 and 32, which are parallel with each other and with shaft 26, and base 32 of the U which connects the two legs. The legs are 22.5° apart so that the rotation of the die rotator and handle assembly is restricted to half the included angle of the polygon defined by the sliders, in this case an octagon. This assures that the die set will be rotated the optimum amount for removal and for installation. The length of the U-shaped legs 31 and 32 may be based on the length of the dies so that the tool will draw the dies into the can. In the absence of stop 28, the U-shaped channel could serve as the stop to prevent over-insertion of the legs into the spaces of the die set. The U-track also prevents relative rotation of the tool until the die rotator is fully inserted.

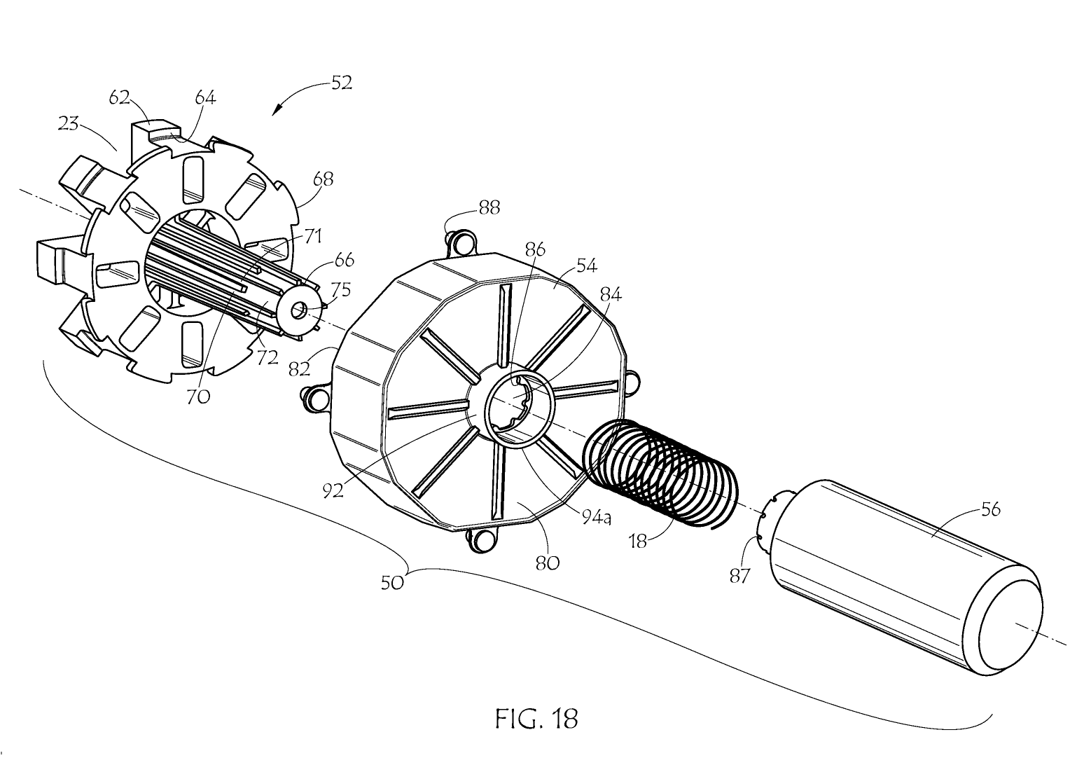

According to the second removal tool embodiment shown in FIG. 18, die removal tool 50 for the installation and removal of interconnected die sets includes a handle assembly and can 54. The handle assembly includes handle 56 and die rotator 52, shown exploded. Handle 56 and die rotator 52 are fastened together, for example, by integral formation, by welding or gluing, or by using a bolt or other suitable fastener through holes 75 and 76. Die rotator 52 includes a plurality of legs 62 and spaces 23 extending radially in a regularly spaced fashion from the end of shaft 66. The size and spacing and number of legs is preferably chosen to match the die set. Again, this die set has eight dies and eight spaces between the dies, so the die rotator preferably has eight legs which fit the spaces between dies when the die is in the fully open position as shown in FIG. 1. The die rotator includes stop 68 to limit how far into the die set spaces the die legs can be inserted. Since the dies will occupy spaces 23, they will not be able to move past stop 68. Legs 62 include detents 64 which are adapted to engage with connectors 192 between the dies. When the detents engage the connectors, the tool will be able to pull the die set out of the crimper and into the can for further handling and/or storage. Detent 64 is again in the form of a step, but other shapes that serve the purpose would be suitable.

According to an embodiment of the invention, there may be eight dies and eight gaps there between, and the connectors may be staggered from gap to gap so that they don't interfere when the dies are contracted together. In this case, only four of the connectors will engage with four rotator legs when the tool pulls them out. On the other hand, when inserting the dies using the tool, all eight dies will contact the die stops so the tool will push them in uniformly. This arrangement facilitates simultaneous engagement of all the dies with the sliders when the die set is rotated into place with the tool.

Can 54 is slidably mounted on the handle assembly so that is can slide along shaft 26 of the die rotator/handle assembly. Thus, can 54 may have open end 82 and closed end 80, so that the die rotator can be housed within the can and be slide in and out of the open end of the can by manipulating the handle. A spring 18 may be used to bias the handle outward from the can and the die rotator into the open end of the can. The spring may be installed within protective housing 94a which mates with recess 94b in handle 56, as shown more clearly in FIG. 19. Thus, spring 18 may be entirely hidden within the tool. The spring may also be retained by shoulder 78, and have other related features as desired. For example, FIG. 19 shows a set of notches 87 which mate with projections on shaft 66 and a hole 76 for a fastener such as a screw or bolt. Can 54 also has four alignment guides in the form of alignment pegs 88 which mate with alignment holes 169 in the four sliders of FIG. 1.

The tool may include means to limit the movement of the handle assembly. In the embodiment of FIG. 18, shaft 66 has a plurality of U-shaped channels which mate with guide protrusions 86 in opening 84 on the closed end 80 of can 54. The U-shaped channels are formed by ridges on shaft 66, resulting in pairs of legs 70 and 71, which are parallel with each other and with shaft 66, and connected by base 72 of the U. The legs are again 22.5° apart so that the rotation of the die rotator and handle assembly is restricted to half the included angle of the polygon defined by the sliders, in this case an octagon. This assures that the die set will be rotated the optimum amount for removal and for installation. In other words, the system of ridges creates several U-shaped tracks in the die rotator, giving it only one degree of freedom relative to the die can. The tool is therefore virtually impossible to misapply without breaking it.

The invention is also directed to methods of using the above described crimper die change tool to install die sets into a crimper and remove die sets from a crimper. The methods generally include the steps of aligning a die change tool with a crimper, rotating the die set by turning the handle during which the dies engage or disengage with sliders on the crimper, and pushing a die set housed in a can on the tool out of the can and into a crimper or pulling the die set crimper into the can.

The die removal process includes inserting a die rotator as described herein into the spaces between adjacent pairs of dies in an interconnected set of crimper dies which are mounted in a crimper; rotating the set of crimper dies by turning a handle attached to the die rotator; engaging at least one detent on the die rotator with at least one die connector; and pulling the set of crimper dies out of the crimper and into a can that is slidably mounted between the die rotator and the handle. The process of rotating the die set causes each of the crimper dies to disengage from its mount in the crimper, thus permitting free axial motion relative to the crimper. Then the die set is simply pulled out of the crimper into the can.

The removal of the die set is facilitated by engaging the can with the crimper to maintain alignment of the can with the crimper at least during the process of rotation, and optionally during the pulling. The pulling may be effected by a spring biasing the handle away from the can, thus biasing the die rotator and the engaged die set into the can. Preferably, the crimper dies define a regular polygon and the amount of rotation selected to be about half the included angle of a side of the polygon. For example, the polygon may be an octagon and the preferred amount of rotation is therefore about 22.5 degrees. The amount of turning may be simply controlled by the user, or the relative motion between the handle/die rotator assembly and the can may be limited by alignment guides thereon as described above. The insertion of the die rotator may also advantageously be limited by a stop thereon which prevents insertion of the legs beyond the crimper dies and/or prevents insertion of the detent beyond the rear face of the crimper dies. The alignment of the can with the opening of the crimper may be facilitated by one or more alignment pegs on the can which align with mating holes on the crimper, or by a can shape that mates with the crimper, or the like.

The process of installing an interconnected set of crimper dies begin the die set housed in the can of a die change tool, which includes a die rotator, a handle, and a can. To insert the die set into a crimper the can is positioned in front of the opening of a crimper. Then pushing the handle causes the die set to slide out of the can into the opening in the crimper. Then rotating the set of dies by turning the handle which is attached to the die rotator causes the dies to engage in the crimper opening. Then the die rotator is removed from the spaces between adjacent pairs of dies in the die set by pulling on the handle.

The process of installing the die set may be facilitated by a stop on the die rotator which pushes on a die or preferably on each of the dies. Likewise, the amount of turning may be simply controlled by the user, or the relative motion between the handle/die rotator assembly and the can may be limited by alignment guides thereon as described above.

The die change tool may also be used to move die sets in and out of die storage containers, as well as in and out of a crimper. The storage system may be a series of compartments of similar size and shape as the can of the die change tool, or similar to the opening of the crimper, namely polygonal in shape. Thus, rotating the die set within the storage compartment also causes the diameter of the die set to change, thus engaging and disengaging one or more of the die connectors with the one or more of the detents on the rotator legs. The storage compartment may also have a way of engaging the dies analogous to what has been described herein when the dies engage the sliders in a crimper. Thus, a single tool may be used to handle a number of die sets for a crimper.

There may be additional variations according to the invention and/or additional uses of the inventive features according to the claims. Following is a more detailed description of a preferred crimp-setting, stop mechanism.

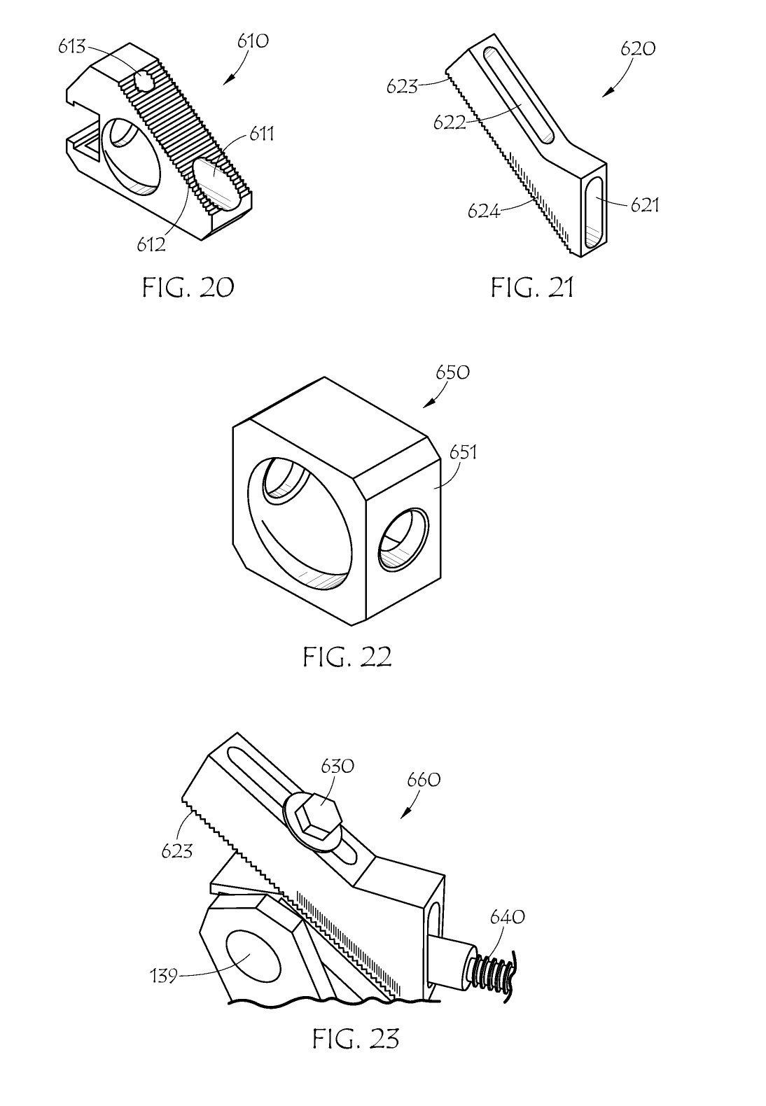

FIGS. 20-24 show a crimp setting mechanism according to an embodiment of the invention, including views of three of the parts thereof and views of the assembly and a crimper using the mechanism. The crimp setting mechanism consists of a first special bushing 610, a crimp stop 620, a connection means 630, a power drive 640, and a second special bushing 650. In the embodiment shown, the first special bushing 610 includes a hole 611 for interfacing with a lead screw power drive 640, multiple steps 612, and a threaded hole 613 for connecting with a thumbscrew or bolt 630. The crimp stop 620 includes a first slot 621 to provide clearance for the lead screw 640, a second slot 622 to provide clearance for a thumbscrew or bolt 630, multiple steps 623 to interface with the steps 612 on the first special bushing, and markings 624 representing crimp settings. The second special bushing 650 includes a stop surface 651.

Note that the power drive 640 in this embodiment is a lead screw, but could potentially be the rod of a hydraulic cylinder or some other means to power the crimp stroke. The connection means 630 in this embodiment is a bolt or thumbscrew or wing-nut or the like, but could also be a means to spring-load or otherwise fasten the first special bushing and crimp stop 620 together. Calibration spacers 662 may be used between the second bushing 650 and the crimp stop 620 to assure that the crimp diameter and crimp setting match up. This method of crimp setting should cost less than others, yet be very user-friendly.

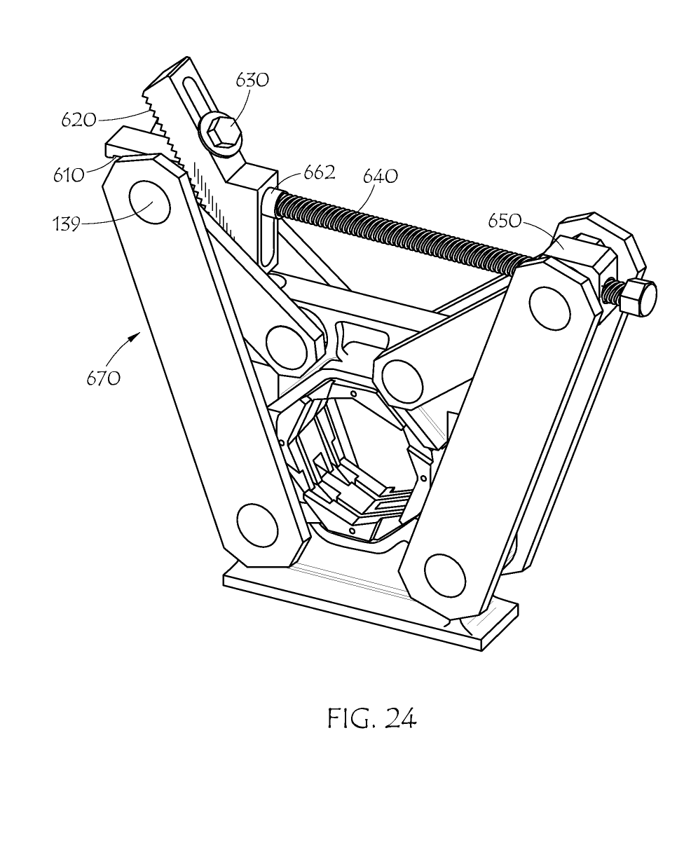

FIG. 24 shows a screw-operated crimper system 670 according to an embodiment of the invention, utilizing crimp setting mechanism 660 according an embodiment of the invention.

The present stepped stop is particularly useful in such a crimper system having a slide frame with a base and a movable head slidably mounted on the slide frame, with a crimp zone opening defined between the base and head, in which there is a dual compound leverage mechanism having two tension arms with lower ends pivotably attached to the base; two compression arms with lower ends pivotably attached to the movable head; and the upper end of each tension arm pivotably attached to the upper end of a corresponding one of the compression arms forming two elbow joints defining acute angles between each tension arm and its corresponding compression arm. In particular, the system may have a drive mechanism adapted to move the two elbows toward each other, thereby driving the head toward the base to perform crimping. The tension arms are advantageously longer than the compression arms and sized to provide a large increase in force as the elbows move toward each other, as illustrated in FIG. 24. Again it should be understood that other drive mechanisms besides the screw shown could be used to power the crimper and utilize the inventive stop.

Thus, the present invention provides a stair-step crimp stop which is easily adjusted through a large range of stop lengths. Steps may be straight or may include a back angle to urge a tighter lock under load. The stepped stop may be held in place with a thumbscrew, wing nut, or the like, or be spring-loaded for even quicker adjustment. The stop arrangement is such that it behaves much like solid material and can withstand the full force of the lead screw in a screw-operated crimper.

Although the present invention and its advantages have been described in detail, it should be understood that various changes, substitutions, and alterations can be made herein without departing from the scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

1-19. (canceled)

20. A crimper die change tool for installing and removing a crimper die set comprising a plurality of circumferentially located crimper dies joined to each other by die connectors, said die change tool comprising:
(i) a handle assembly comprising:
a handle on one end, and
a die rotator mounted on an end opposite said handle; and
(ii) a can having a length and diameter sufficient to house said crimper die set and comprising an open end and a closed end, with said can slidably mounted on said handle assembly so that said die rotator can be moved in and out of said can through said open end.

21. The tool of claim 20 wherein said die rotator comprises a plurality of radial legs which fit between said crimper dies when said die set is in an open position.

22. The tool of claim 21 wherein each said leg comprises a detent, and said detents pass freely over said connectors when said die set is in a fully open position, and at least one said detent engages at least one said connector for pulling said die set into said can when said die set is in a partially closed position.

23. The tool of claim 22 wherein said die rotator further comprises at least one stop for limiting the distance of insertion of the rotator legs between crimper dies.

24. The tool of claim 23 comprising a stop for each die for uniformly pushing a set of dies out of said can.

25. The tool of claim 20 further comprising: a spring arranged to urge said die rotator into said can.

26. The tool of claim 20 wherein said can comprises at least one alignment guide on the periphery of said can to engage with said crimper and prevent relative motion between said crimper and said can.

27. The tool of claim 20 wherein said can further comprises an alignment protrusion; and
said handle assembly comprises an U-shaped track oriented axially with open end of the U toward said die rotator;
with said alignment protrusion engaged in said track for guiding and limiting both axial and rotational movement of said handle assembly relative to said can.

28. A method comprising:
inserting a die rotator into the spaces between adjacent pairs of dies in an interconnected set of crimper dies mounted in a crimper;
rotating said set of crimper dies by turning a handle attached to said die rotator;
engaging at least one detent on said die rotator with at least one die connector; and
pulling said set of crimper dies out of a crimper and into a can that is slidably mounted between said die rotator and said handle.

29. The method of claim 28 wherein said rotating causes each said crimper die to disengage from its mount in said crimper for free axial motion relative to said crimper.

30. The method of claim 28 further comprising engaging said can with said crimper to maintain alignment of can with crimper during said rotation.

31. The method of claim 28 wherein said crimper dies define a regular polygon and said rotation is limited to half the included angle of a side of said polygon.

32. A method of installing an interconnected set of crimper dies into a crimper comprising:
with said set of dies housed in the can of a die change tool comprising a die rotator, a handle, and a can, pushing said handle to slide said die set out of said can into a suitable opening in said crimper;
rotating said set of dies by turning said handle which is attached to said die rotator to engage said dies in said opening;
removing said die rotator from the spaces between adjacent pairs of dies in said set by pulling on said handle.

33. The method of claim 32 wherein said rotating causes each said crimper die to engage its mount in said crimper to prevent axial motion relative to said crimper.

34. The method of claim 32 further comprising engaging said can with said crimper to maintain alignment of can with crimper during said rotation.

35. The method of claim 32 wherein said crimper dies define a regular polygon and said rotation is limited to half the included angle of a side of said polygon.

36. A crimper die system comprising a die change tool for installing and removing a crimper die set from a crimper and a crimper die set comprising a plurality of circumferentially located crimper dies joined to each other by die connectors;
said die change tool comprising:
(i) a handle assembly comprising:
a handle on one end, and
a die rotator mounted on an end opposite said handle; and
(ii) a can having a length and diameter sufficient to house said crimper die set and comprising an open end and a closed end, slidably mounted on said handle assembly so that said die rotator can be moved in and out of said can through said open end.

37. The system of claim 36 wherein said die connectors limit the radial expansion of said die set to a fully open position;
said die connectors comprise springs which urge the dies toward said fully open position; and
said die connectors and said springs permit the contraction of the die set to a fully closed position.

38. The system of claim 36 wherein said die rotator comprises a plurality of radial legs which fit between said crimper dies when said die set is open.

39. The system of claim 38 wherein each said leg comprises a detent, and said detents pass freely over said connectors when said die set is in a fully open position, and said detents engage said connectors for pulling said die set into said can when said die set is in a partially closed position.

40. The system of claim 39 wherein rotation of said die rotator with said handle after insertion of die rotator into said die set results in rotation of said die set by means of contact between said legs and said dies, and said rotation results in said die set moving from said fully open position to said partially closed position.

41. The system of claim 36 wherein said change tool further comprises: a spring arranged to urge said die rotator into said can.

42. The system of claim 36 wherein said can comprises at least one alignment guide on the periphery of said can to engage with said crimper and prevent relative motion between said crimper and said can.

43. The system of claim 36 wherein said can further comprises an alignment protrusion; and
said handle assembly comprises an U-shaped track oriented axially with open end of the U toward said die rotator;
with said alignment protrusion engaged in said track for guiding and limiting both axial and rotational movement of said handle assembly relative to said can.

44. The system of claim 36 wherein said die rotator further comprises at least one stop for limiting the distance of insertion of the rotator legs between crimper dies.

45-51. (canceled)
